(19) United States
(12) Patent Application Publication
(10) Pub. No.: US 2017/0286982 A1
(43) Pub. Date: Oct. 5, 2017

(54) SYSTEM AND METHOD FOR TERRITORY ASSIGNMENT

(71) Applicant: VEEVA SYSTEMS INC., Pleasanton, CA (US)

(72) Inventors: John Howard, San Ramon, CA (US); Elie Challita, San Francisco, CA (US); Gregory Barker, Pleasanton, CA (US); Alan Wang, Dublin, CA (US)

(73) Assignee: Veeva Systems Inc., Pleasanton, CA (US)

(21) Appl. No.: 15/091,347

(22) Filed: Apr. 5, 2016

(51) Int. Cl. G06Q 30/02; G06F 17/30

(52) U.S. Cl. CPC G06Q 30/0205; G06F 17/30241; G06F 17/30575

(57) ABSTRACT

Systems and methods for managing territory assignment for a CRM system. Customer data may be loaded from the CRM system to a memory device and mapped to data fields of the memory device. Rides may be received and executed to process customer data to determine territory of each account in the customer data. The territory information may then be stored in a territory management database and synchronized to the CRM system and other CRM systems.

### BACKGROUND

The subject technology relates generally to customer relationship management (“CRM”), and more particularly to territory management for CRM systems.

In the pharmaceutical sales industry, sales representatives visit, call or send emails to physicians to communicate product information. Their company employers (e.g., pharmaceutical companies) often use a CRM system to manage the physicians' professional information. A company may also manage data availability to its sales representatives by territories, which could be a geographic area, an affiliation or a product. Each sales representative may access data in the CRM of his/her company employer, specifically data of physicians in the territory he/she is assigned to. Thus, it, is desirable to provide a method to manage the territory information efficiently.

### SUMMARY

The disclosed subject matter relates to a method for managing territory information for a CRM system. The method comprises: loading customer data from the CRM system to a memory device, wherein the customer data comprises account information and wherein the account information comprises names and addresses of a first account and a second account. The method timber comprises: receiving a first rule for territory assignment for a first territory, wherein the first rule comprises a first rule criterion for defining accounts in the first territory. The method further comprises: receiving a request for executing the first rule to process the customer data; processing the customer data with the first rule to determine that the first account belongs to the first territory according to account information of the first account and the first rule criterion; assigning the first account to the first territory; and storing the first territory as the first account's territory information in a territory management database.

### BRIEF DESCRIPTION OF THE DRAWINGS

FIG. 1 illustrates an example high level block diagram of an enterprise data management architecture wherein the present invention may be implemented.

FIG. 2 illustrates an example high level block diagram of a computing device.

FIG. 3 illustrates an example high level block diagram of territory information management server according to one embodiment of the present invention,

FIG. 4 illustrates an example flowchart of a method for managing territory assignment according to one embodiment of the present invention.

FIG. 5 illustrates an example of field mapping during territory assignment according to one embodiment of the present invention.

FIG. 6 illustrates an example of a user interface fir receiving definition of a rule for managing territory assignment according to one embodiment of the present invention.

FIG. 7 illustrates an example of a user interface for displaying territory information according to one embodiment of the present invention,

FIG. 8 illustrates an example of a user interface for displaying CRM synchronization information according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

The subject technology is directed to techniques for managing territory information for an enterprise. A CRM system may be used to hold and manage the enterprise's data. The CRM system may store customer account information for the enterprise.

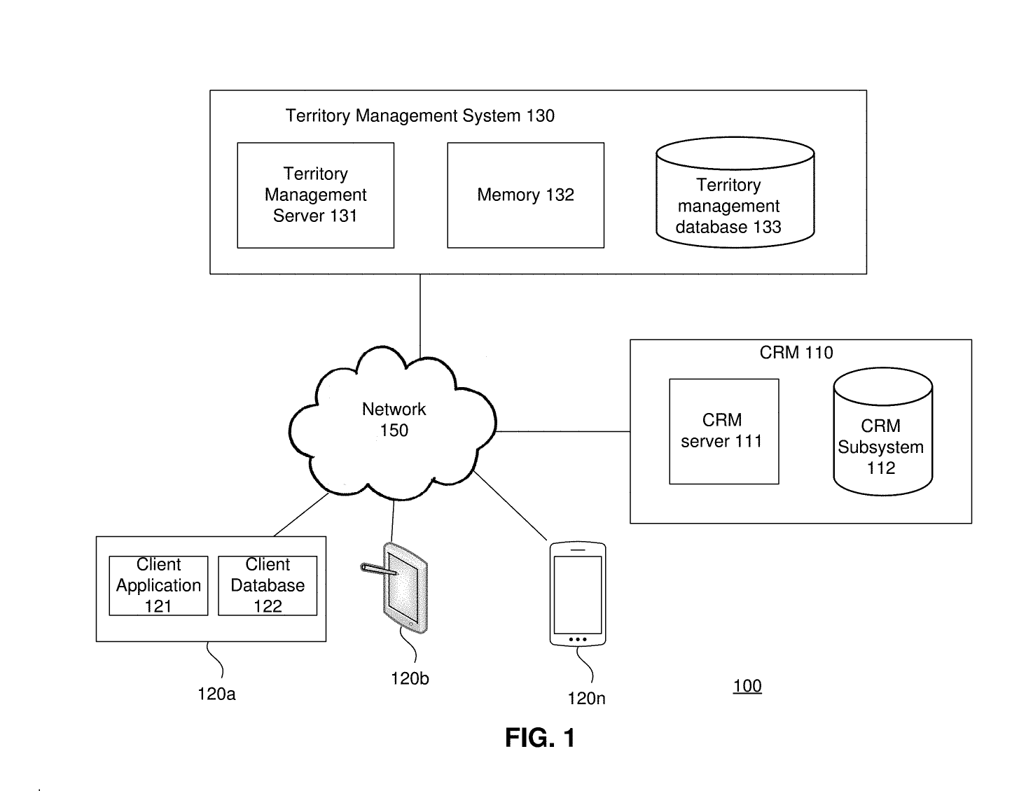

FIG. 1 illustrates an example high level block diagram of an enterprise data management architecture 100 wherein the present invention may be implemented. The enterprise may be a business, or an organization. As shown, the architecture 100 may include a CRM system 110, a plurality of user computing devices 120a , 120b, . . . 120n , and a territory management system 130, coupled to each other via a network 150. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a-120n may be any machine or system that is used by a user to access the CRM 110 via the network 150, and may be laptop computers, desktop computers, mobile phones, smart phones, tablet computers, netbooks, and personal digital assistants (PDAs). A client application 121 may run from a user computing device, e.g., 120a , and access data in the CRM 110 via the network 150. To enable a sales representative to use the client application 121 even when the user computing devices 120a -120n are disconnected and provide seamless transition between online and offline use, a client database 122 for the client application 121 may store a subset of the customer data in the CRM 110 which may be needed to support the sales representative's use of the client application 121. In order to provide users correct and newest information, the client database 122 may be synchronized with the CRM 110 regularly according to a preset schedule, when the user computing device is back online, and/or when the user requests for synchronization.

The CRM 110 may have a CRM server 111 and a CRM subsystem 112. The CRM server 111 is typically a remote computer system accessible over a remote or local network, such as the network 150. A client application (e.g., 121) process may be active on one or more user computing devices 120a -120n , and the corresponding server process may be active on the CRM server 111. The client application process and the corresponding server process may communicate with each other over the network 150, thus providing distributed functionality and allowing multiple client applications to take advantage of the information-gathering capabilities of the CRM 110. The CRM server 111 may control access to data in the CRM subsystem 112.

The CRM subsystem 112 may store data that client applications (e.g., 121) in user computing devices 120a -120n may use. In one embodiment, the CRM subsystem 112 may store customer data that pharmaceutical companies may need when promoting new products, which may include physician professional information (e.g., name, specialty, license information, affiliated health care organization (“HCO”), contact information at the affiliated HCO, prior interaction record, electronic signature for samples, and medical inquiry submission), product information (e.g., name, category, lot and statistics), sales representative information (e.g., name, territory information, sharing rules and sales reports). It should be understood that the CRM subsystem 112 may store data for other industries. Each physician may be an account in the CRM 110.

In one embodiment, the CRM 110 may be a multi-tenant system where various elements of hardware and software of the CRM 110 may be shared by one or more customers. For instance, a server may simultaneously process requests from a plurality of customers, and a database table may store rows for a plurality of customers. In a multi-tenant system, a user is typically associated with a particular customer. In one example, a user could be a sales representative of one of a number of pharmaceutical companies which are tenants, or customers, of the CRM 110.

In one embodiment, the CRM 110 may be a cloud database which runs on a cloud computing platform. Users can run databases on the cloud independently by using a virtual machine image, or purchasing access to a database service maintained by a cloud database provider.

The territory management system 130 may include a territory management server 131, a memory 132, and a territory management database 133. The memory 132 may temporarily store territory assignment information before it is sent to the territory management database 133.

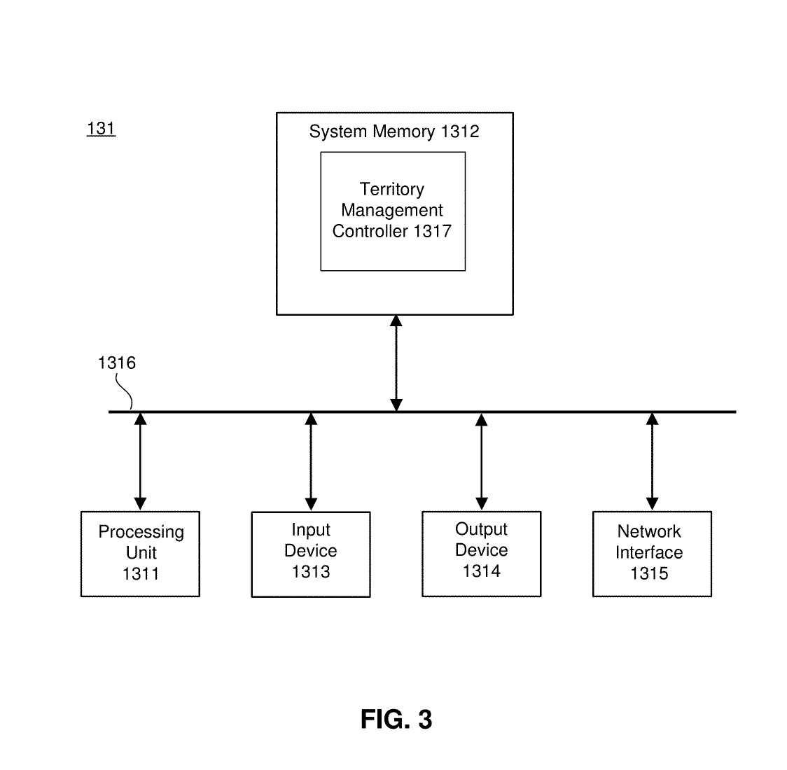

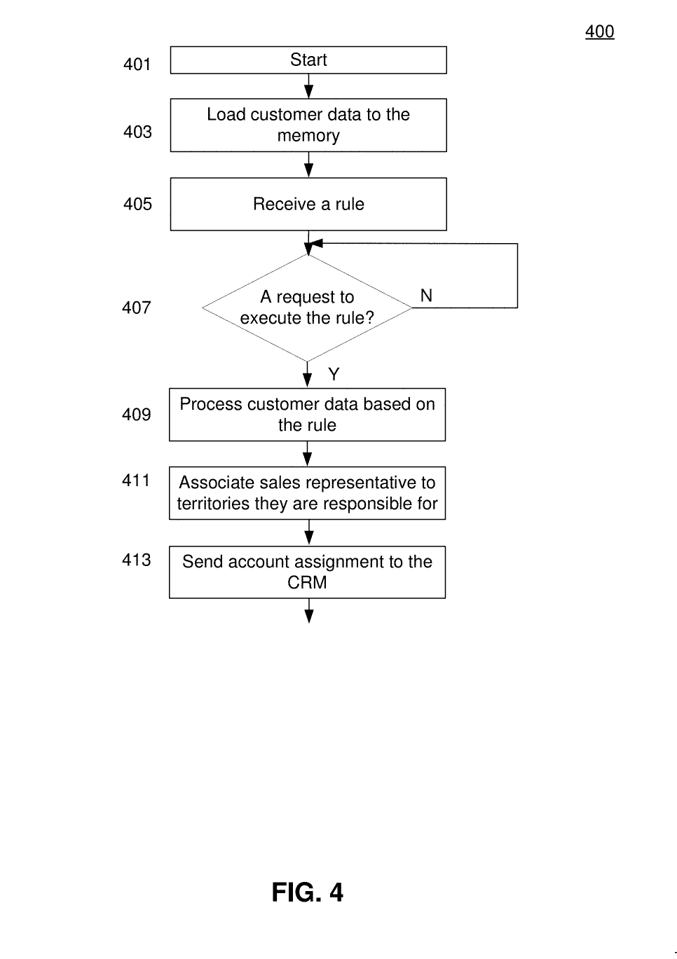

The territory information management server 131 may be used to, as shown in FIG. 4, control the process for assigning territory information.. The territory management server 131 may further send any updated territory information to the CRM 110, so that the CRM 110 may be updated with the changes. The updates may then be synced down to the client database 122. The territory management server 131 is illustrated in more detail in FIG. 3.

In one embodiment, the client application 121 is a sales tool for helping sales representatives of pharmaceutical companies (i.e., customers) to promote products to physicians (“accounts”). Each of the pharmaceutical companies may store physician professional information it collected and/or purchased in the CRM 110. An administrative user of a pharmaceutical company may manage data availability to its sales representatives by territories, which could be a geographic area, an affiliation or a product. A sales representative may access data in the CRM 110 of the pharmaceutical company be works for, specifically data for physicians in one or more territories he/she is assigned to. A pharmaceutical company may store information of tens of thousands of physicians and hundreds of products in the CRM 110, but a sales representative may be allowed to access information of only a subset of the physicians (e.g., hundreds) and/or a subset of the products (e.g., tens) which are in the territory he/she is assigned. In one example, the customer data may be physician professional information of cardiologists in the U.S. compiled and/or purchased by a pharmaceutical company.

In one implementation, the client database 122 may store a subset of data from the CRM subsystem 112 which may be needed to support the operation of the client application 121. The data in the client database 122 may be associated with a specific sales representative, and only data that the sales representative is allowed to use %k hen running the client application 121 on his/her user computing device 120a may be downloaded to the user computing device 120a during synchronization with the CRM 110. Such information may include, e.g., data related to the subset of physicians and/or products in his/her territory.

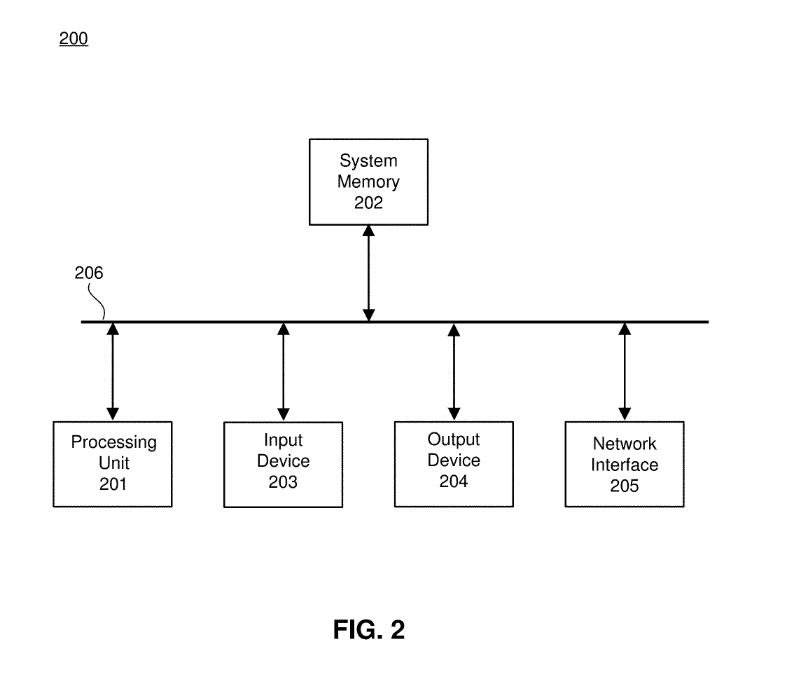

FIG. 2 illustrates an example high level block diagram of a computing device 200 which can be used as the user computing devices 120a -120n, the territory information management server 131, and/or the CRM server 111 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

FIG. 3 illustrates an example high level block diagram of the territory information management server 131. The territory management server 131 may be implemented by the computing device 200, and may have a processing unit 1311, a system memory 1312, an input device 1313, an output device 1314, and a network interface 1315, coupled to each other via a system bus 1316. The system memory 1312 may store a territory management controller 1317, which may be used to control the process for territory assignment shown in FIG. 4. In one embodiment, the territory information management server 131 may be implemented in a cloud environment, and the territory management controller 1317 may ran on an elastic computing platform.

FIG. 4 illustrates an example flowchart of a method for territory assignment according to one embodiment of the present invention. The process may start at 401.

At 403, customer data may be loaded to the memory 132. In one implementation, the customer data may be those that pharmaceutical companies may need to promote new products, and may include physician professional information (e.g., name, specialty, license information, affiliated health care organization (“HCO”), contact information at the affiliated HCO, prior interaction record., electronic signature for samples, and medical inquiry submission), product information (e.g., name, category, lot and statistics), and sales representative information (e.g., name, territory information, sharing rules and sales reports). The customer data may be accessed from the CRM 110 or another CRM. Alternatively, customer data may be imported by a customer, e.g., from another data storage device. The customer data may be in various formats, e,g., Excel or CSV (“Comma Separated Values”) file.

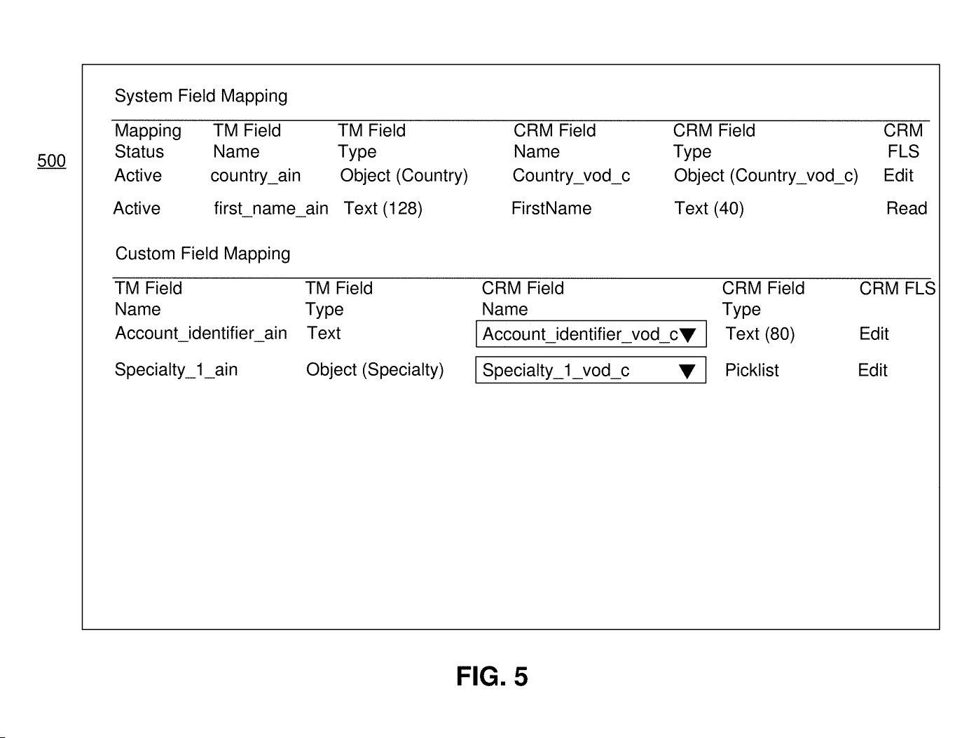

In one implementation, field mapping may be enabled between the territory management system 130 and one or more CRM systems (e.g., the CRM 110). As shown in FIG. 5, field mapping may include system field mapping and custom field mapping. For data fields commonly used in various types of CRM systems (e.g., names and countries of these accounts), the system field mapping may be set as active. The fields in the territory management system 130 may be mapped to their corresponding fields in the CRM systems, so that data may be imported from the CRM systems into corresponding fields in the territory management system 130. Alternatively, an administrative user may configure custom field mapping, and select from a drop-down or pop-up picklist the field in the CRM system to be mapped to a field in the territory management system 130, e.g., account identifier and specialty. In one implementation, an API call may be made to a CRM system to get information of its fields.

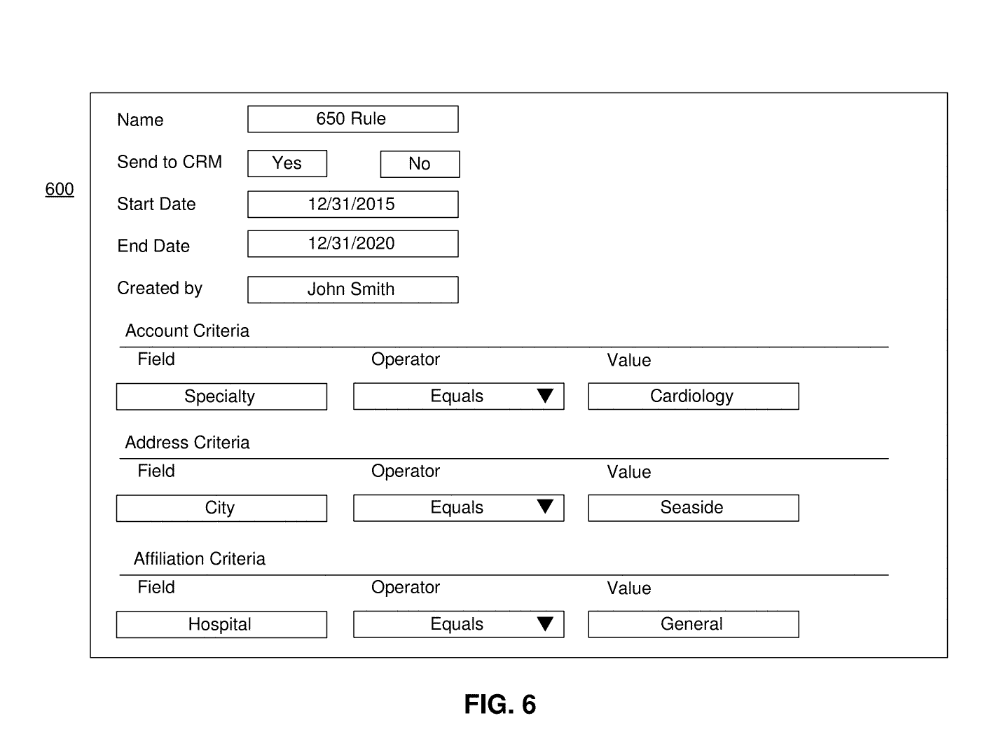

At 405, a rule may be received at the territory management server 131. The rule may he created by the administrative user, e.g., with a user interface 600 in FIG. 6. Different objects may be joined together to define the rule. As shown, the administrative user may input the name of the rule (e.g., Rule 650), its start date and its end date on the user interface 600. The user may also input criteria of the rule, e.g., a specialty, a geographic area, and/or an affiliation. The criteria may be any information that may be searched for in order to filter or reduce the number of accounts to be assigned to a territory. The rule criteria may be, e.g., account criteria used to search information of the accounts, and address criteria used to search the addresses of the accounts. In the example shown, the criteria of the Rule 650 determine cardiologists in the Seaside city. In another implementation, a zip code may be combined with a specialty to define a rule of territory assignment.

In one implementation, the user may input the rule criteria via a pop-up or dropdown menu by clicking on one of the windows, e.g., Field, Operator, or Value.

At 407, it may be determined if a request to execute the rule is received at the territory management server 131. The administrative user may submit the request by clicking on a button “Submit” or “Execute” on the user interface 600.

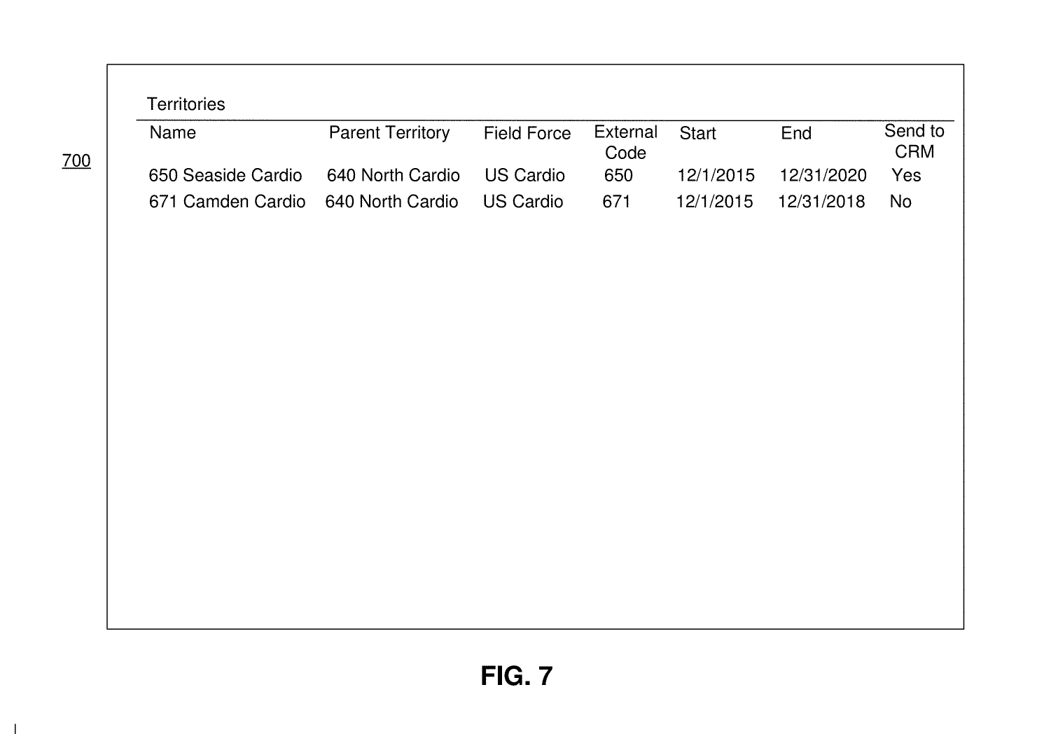

If yes, at 409, the rule may be executed to create account assignments in a dynamic nature. As shown in FIG. 7, a rule is created for a territory, e.g., the Rule 650 is created for a territory “650 Seaside Cardio”. A territory ID (e.g., 650) may be assigned to the territory “650 Seaside Cardio”, Customer data may be processed based on the rule. For the Rule 650, it may he determined if a physician should be assigned to the territory “650 Seaside Cardio” based on his account information (e.g., specialty and geographic location) and the rule criteria. The account assignments may indicate, e.g. which accounts are assigned to the territory based on the rule. The territory “650 Seaside Cardio” may then be assigned to accounts satisfying the Rule 650, and the territory assignment information may be stored in the memory 132.

In one implementation, a manual option may be provided. When the administrative user knows the account, or does not have enough data to have a rule in place, or when the data is not consistent enough, the user may manually assign an account to a territory.

At 411, sales representatives may be associated with the territory they are responsible for. In one implementation, a territory ID (e.g., 650) may be associated with one or more sales representatives responsible for the territory “650 Seaside Cardio”, so that they can have access to account information of physicians with the same territory ID. In one implementation, a sales representative group may be assigned to the territory, and sages representatives responsible for this territory may be added to the group.

In one implementation, the account assignments may be displayed in a preview user interface before being sent from the memory 132 to the territory management database 133, so as to give the user an opportunity to view and check the result, e,g., the number of HCP assigned.

At 413, the territory assignments may be sent from the territory management database 133 to the CRM 110 to be integrated with the account information there. When the field “Send to CRM” on the user interface 700 is set as “yes”, the territory assignments may be sent to the CRM 110 automatically, in one implementation, the territory assignment information may be sent to multiple CRM systems.

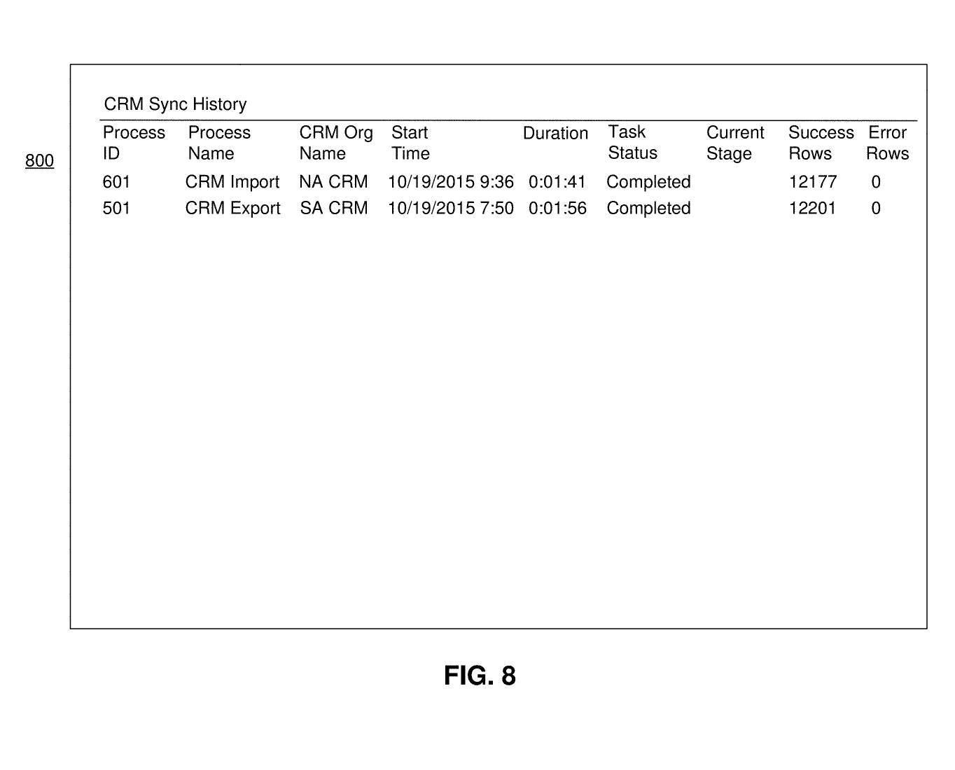

In one implementation, a CRM synchronization history may be displayed on a user interface 800, as shown in FIG. 8, The CRM synchronization history may include the data exchange history between the territory management system 130 and one or more CRM systems, e,g,, the data import from the one or more CRM systems, and the data export to the one or more CRM systems. The CRM synchronization history may also indicate the status of the integration with the account information in the one or more CRM systems. Such status may include how many rows have been exported to a. CRM system from the territory management system, imported to the territory management system 130 from a CRM system, and the integration result (e, g, completed).

When a second rule is received for a second territory, 405 to 413 may be repeated to process the customer data to determine the accounts in the second territory and synchronize the new territory assignment information to the one or more CRM systems.

Consequently, sales representatives may access the territory assignment information, including account information of physicians in his territory, from the CRM 110 or the client database 122.

When account information changes, e.g.,, when a physician moved from one geographic territory to another, hiss her territory may be updated by, the territory management system 130. When the business plan changes, administrative users may update territories assigned to a field representative,

The above-described features and applications can be implemented as software processes that are specified as a set of instructions recorded on a computer readable storage medium (also referred to as computer readable medium). When these instructions are executed by one or more processing Lungs) (e,g,, one or more processors, cores of processors, or other processing units), they cause the processing unit(s) to perform the actions indicated in the instructions. Examples of computer readable media include:, but are not limited to, CD-ROMs flash drives, RAM chips, hard drives, EPROMs, etc. The computer readable media does not include carrier waves and electronic signals passing wirelessly or over wired connections,

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks,

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies, in some implementations, multiple software technologies can also be implemented as separate programs. Finally, airy combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher/level code that are executed b a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e,g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be preformed. Some of the steps may be performed simultaneously. For example, in certain circumstances, multi tasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects >ill be readily apparent, and the generic principles defined herein may be applied to other aspects. Thus, the claims are not intended to be limited to the aspects shown herein but is to be accorded the full scope consistent with the language claims, where reference to an element in the singular is not intended to mean “one and only one” unless specifically so stated, but rather “one or more.” Unless specifically stated otherwise, the term “some” refers to one or more.

1. A method for managing territory assignment for a customer relationship management (“CRM”) system, the method comprising:
loading customer data from the CRM system to a memory device, wherein the customer data comprises account information and wherein the account information comprises names and addresses of a first account and a second account;
receiving a first rule for territory assignment for a first territory, wherein the first rule comprises a first rule criterion for defining accounts in the first territory;
receiving a request for executing the first Me to process the customer data;
processing the customer data with the frit rule to determine that the first account belongs to the first territory according to account information of the first account and the first rule criterion;
assigning the first account to the first territory; and
storing the first territory as the first account's territory information in a territory management database.

2. The method of claim 1, further comprising: associating a first user with the first territory.

3. The method of claim 2, further comprising: creating a user group for the first territory; and adding the first user to the user group for the first territory.

4. The method of claim 1, further comprising: updating the CRM system with the first account's territory information from the territory management database.

5. The method of claim 4, further comprising: updating a second CRM system with the first account's territory information from the territory management database.

6. The method of claim 1, wherein the first rule comprises a second rule criterion for defining accounts in the first territory.

7. The method of claim 6, wherein the second rule criterion comprises a specialty of the account,

8. The method of claim 7, wherein the first rule criterion and the second rule criteria are joined together to define the first rule.

9. The method of claim 1, wherein the first rule comprises a third merle criterion for defining accounts in the first territory.

10. The method of claim 9, wherein the third rule criterion comprises an affiliation of the account.

11. The method of claim 1, wherein the first rule criterion is defined by a first object.

12. The method of claim 1, further comprising: displaying the first territory as the first account's territory information in a preview user interface before storing such information in the territory management database.

13. The method of claim 1, further comprising: displaying a CRM synchronization history which includes data exchange history between the territory management database and the CRM system.

14. The method of claim 1, further comprising: mapping data fields in the customer data to data fields in the memory device.

15. The method of claim 1, further comprising: receiving a second de for territory assignment fur a second territory.

16. The method of claim 15, further comprising: processing the customer data with the second rule to determine that the second account belongs to the second territory.

17. The method of claim 16, further comprising: assigning the second account to the second territory.

18. The method of claim 17, further comprising: storing the second territory as the second account's territory information in the territory management database.

19. A territory assignment system for a customer relationship management (“CRM”) systm, the territory assignment system comprising a territory management controller for:
loading customer data from the CRM system to a memory device, wherein the customer data comprises account information and wherein the account information comprises names and addresses of a first account and a second account;
receiving a first rule for territory assignment for a first territory and a second rule for territory assignment for a second territory, wherein the first and second rules are used to process the account information in the customer data;
processing the customer data with the first rule to determine that the first account belongs to the first territory;
assigning the first account to the first territory;
storing the first territory as the first account's territory information in a territory management database;
processing the customer data with the second rule to determine that the second account belongs to the second territory;
assigning the second account to the second territory; and
storing the second territory as the second account's territory information in the territory management database.

20. The territory assignment system of claim 19, wherein the territory controller runs on an elastic computing platform.
